(19) United States
(12) Patent Application Publication
(10) Pub. No.: US 2012/0135300 A1
(43) Pub. Date: May 31, 2012

(54) BATTERY STORAGE CASE AND BATTERY PACK HAVING THE SAME

(76) Inventor: Shinji Ota, Osaka (JP)

(21) Appl. No.: 13/387,037

(22) PCT Filed: Jan. 14, 2011
(86) PCT No.: PCT/JP11/00178

§ 371 Date: Jan. 25, 2012

(30) Foreign Application Priority Data
Feb. 2, 2010 (JP) 2010-021116

(51) Int. Cl. H01M 2/02

(52) U.S. Cl. 429/176

(57) ABSTRACT

The present invention provides a battery storage case capable of achieving easier insertion of an adhesive projection into an adhesion groove and ensuring adhesion sealability, and a battery pack having this battery storage case. The battery storage case includes: first and second cases 4 and 3 for sandwiching and storing a battery 2 therebetween in a predetermined sandwiching direction; an adhesive projection 10 provided in the first case 4; and an adhesion groove 7 provided in the second case 3, wherein the width of the adhesion groove 7 is set to be greater than the thickness of the adhesive projection 10, and the first case 4 and the second case 3 can be adhered to each other in a state that a clearance K1 on the outer circumference side of the adhesive projection 10 is different from a clearance K2 on the inner circumference side of the adhesive projection 10 over the entire circumference of an axis parallel to the sandwiching direction.

### TECHNICAL FIELD

The present invention relates to a battery pack in which a battery is stored between a pair of cases made from a thermoplastic resin.

### BACKGROUND ART

A battery pack that has a pair of cases made from a thermoplastic resin and a battery stored therebetween has conventionally been known. Peripheral edges of the cases are ultrasonically adhered to each other to hold the battery therebetween.

Patent Document 1, for example, discloses an equipment case having one battery case and the other battery case. This equipment case is produced as follows. An adhesive rib projecting from a joining face of the one battery cases is inserted into an adhesion groove formed in the other battery case. In this state an ultrasonic vibration is applied to cause the adhesive rib and a wall surface of the adhesion groove to vibrate, thereby fusing the adhesive rib. The both battery cases are ultrasonically adhered to each other as the fused part is hardened.

When inserting the adhesive rib into the adhesion groove to perform the ultrasonic adhesion as in this equipment case of Patent Document 1, the adhesive rib can be inserted easily into the adhesion groove by increasing the width of the clearance between the adhesive rib and the adhesion groove.

However, simply increasing the width of the clearance between the adhesive rib and the adhesion groove is not enough to ensure sufficient adhesion sealability (waterproof characteristics) due to the occurrence of a wide space that fills the fused part of the adhesive rib in the adhesion groove.
Patent Document 1: Japanese Patent Application Laid-open No. 2001-313014

### SUMMARY OF THE INVENTION

An object of the present invention is to provide a battery storage case capable of achieving easier insertion of an adhesive projection into an adhesion groove and ensuring adhesion sealability, and a battery pack having this battery storage case.

In order to achieve the object described above, the present invention provides a battery storage case, having: first and second cases for sandwiching and storing a battery therebetween in a predetermined sandwiching direction; an adhesive projection provided in the first case and projecting toward the second case over the entire circumference of an axis parallel to the sandwiching direction; and an adhesion groove provided in the second case and depressed over the entire circumference of the axis parallel to the sandwiching direction, wherein a width of the adhesion groove is set to be greater than a thickness of the adhesive projection, and the first case and the second case can be adhered to each other in a state that a clearance on an inner circumference side of the adhesive projection is different from a clearance on an outer circumference side of the adhesive projection over the entire circumference of the axis parallel to the sandwiching direction.

The present invention also provides a battery pack that has a battery and the battery storage case, wherein the first case and the second case of the battery storage case are ultrasonically adhered to each other while sandwiching the battery therebetween.

### BRIEF DESCRIPTION OF THE DRAWINGS

FIG. 1 is an exploded perspective view showing the entire configuration of a battery pack according to an embodiment of the present invention.

FIG. 2 is a cross-sectional diagram taken along line II-II shown in FIG. 1.

FIG. 3 is a cross-sectional diagram showing first and second cases of FIG. 2 prior to adhesion.

FIG. 4 is a cross-sectional diagram showing a procedure of ultrasonically adhering the first and second cases shown in FIG. 1, wherein FIG. 4A shows a state that an adhesive projection 10 is inserted into an adhesion groove 7, FIG. 4B shows a state that the ultrasonic adhesion is started, and FIG. 4C shows a state that the ultrasonic adhesion is completed.

### DESCRIPTION OF EMBODIMENTS

An embodiment of the present invention is described hereinafter with reference to the accompanying drawings. The following embodiment is merely an example of the present invention and therefore does not limit the technical scope of the present invention.

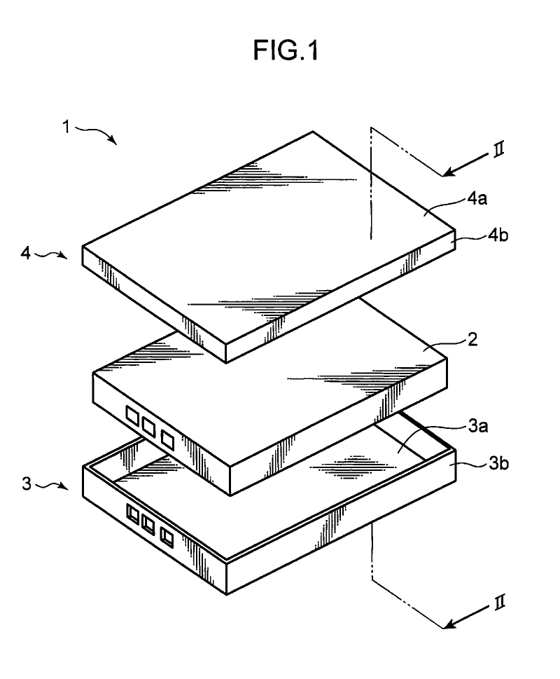

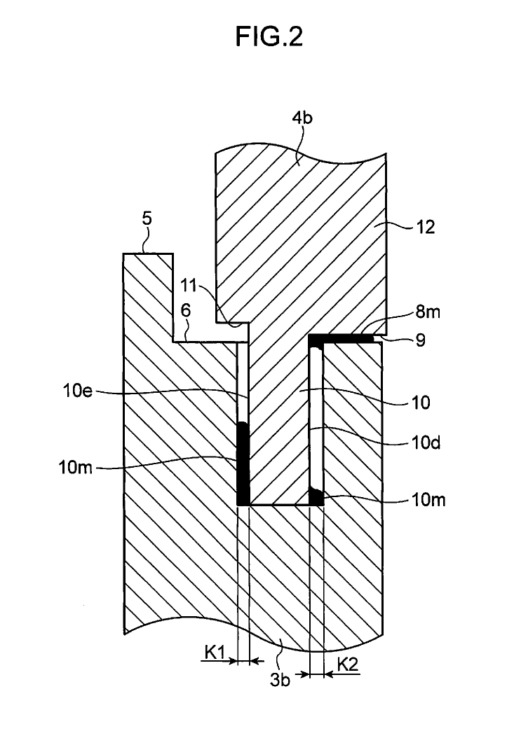

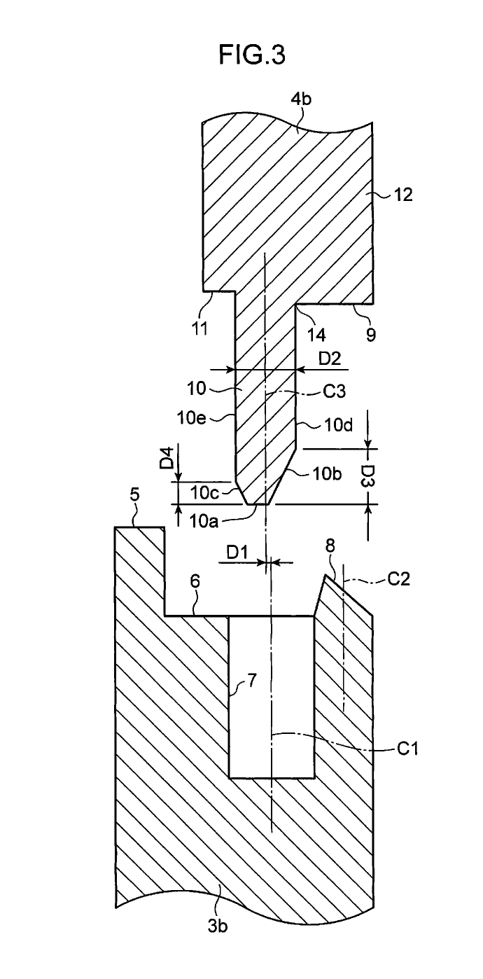

FIG. 1 is an exploded perspective view showing the entire configuration of a battery pack according to the embodiment of the present invention. FIG. 2 is a cross-sectional diagram taken along line II-II shown in FIG. 1. FIG. 3 is a cross-sectional diagram showing first and second cases of FIG. 2 prior to adhesion.

Referring to FIGS. 1-3, a battery pack 1 has a battery 2 and first and second cases 4 and 3 for sandwiching and storing the battery 2 therebetween in a predetermined sandwiching direction (the vertical direction in FIG. 1).

The second case 3 is made from a thermoplastic resin. The second case 3 has a substantially rectangular bottom plate 3a, and a side wall 3b extending from a peripheral edge part of the bottom plate 3a to the first case 4 side over the entire circumference of the peripheral edge part. As shown in FIG. 3, the side wall 3b has a lower part 6 that is formed to be lower than a tip end surface 5 of the first case 4, an adhesion groove 7 formed in this lower part 6, and an auxiliary adhesive projection 8 that projects from an open rim part formed on the inside of the adhesion groove 7 toward the first case 4 (the upper side of FIG. 3).

The adhesion groove 7 makes a recess on the lower part 6. In other words, the adhesion groove 7 is opened toward the first case 4 side to have a rectangular cross section that is line-symmetric with respect to a centerline C1 parallel to the sandwiching direction, and extends over the entire circumference of an axis parallel to the sandwiching direction.

The auxiliary adhesive projection 8 projects toward the first case 4 from the lower part 6 that is located on the inside of the adhesion groove 7, over the entire circumference of the axis parallel to the sandwiching direction. Specifically, the auxiliary adhesive projection 8 has a triangular cross section that tapers such that a thickness central position on the tip end side of the auxiliary adhesive projection 8 is closer to the adhesion groove 7 (toward an adhesive projection 10 described hereinafter) than a thickness central position on the base end side of the auxiliary adhesive projection 8. In other words, in the present embodiment the apex of the auxiliary adhesive projection 8 is closer to the adhesion groove 7 than a centerline C2 of a thickness direction of the base end part of the auxiliary adhesive projection 8. Note in the present embodiment that a thickness centerline of the lower part 6 on the inside of the adhesion groove 7 is same as the thickness centerline C2 of the base end part of the auxiliary adhesive projection 8.

As shown in FIGS. 1 to 3, the first case 4 is made from a thermoplastic resin. The first case 4 has a substantially rectangular ceiling plate 4a, and a side wall 4b extending from a peripheral edge part of the ceiling plate 4a to the second case 3 side over the entire circumference of the peripheral edge part. As shown in FIG. 3, the side wall 4b has a side wall main body 12 having end surfaces 9, 11 facing the second case 3, and the adhesive projection 10 projecting from the side wall main body 12 to the second case 3 between the end surfaces 9, 11.

The end surfaces 9, 11 extend from side surfaces of the adhesive projection 10 in a direction perpendicular to the sandwiching direction (the horizontal direction in FIG. 3). In the present embodiment, the end surface 9 is disposed closer to the second case 3 than the end surface 11, and functions as an adhesion surface for adhering the auxiliary adhesive projection 8. More specifically, the end surface 9 extends from the side surface of the adhesive projection 10 to form, between the end surface 9 and the side surface of the adhesive projection 10, an angular part 14 (see FIG. 3) for accumulating a fusion part of the auxiliary adhesive projection 8.

The adhesive projection 10 projects from the side wall main body 12 toward the second case 3 over the entire circumference of the axis parallel to the sandwiching direction. Specifically, the adhesive projection 10 has a tip end surface 10a configured by a flat surface substantially perpendicular to the sandwiching direction, first and second inclined surfaces 10c and 10b that are inclined at either end of the thickness direction (the horizontal direction in FIG. 3) of the adhesive projection 10 by broadening from the tip end surface 10a toward the base end part (the upper side of FIG. 3), and first and second side surfaces 10d and 10e that extend from the inclined surfaces 10b and 10c, respectively, toward the base end part (the upper side of FIG. 3) along a direction substantially parallel to the sandwiching direction. In the present embodiment the first and second side surfaces 10d and 10e are parallel to each other.

As shown in FIG. 2, in the present embodiment the first case 4 and the second case 3 can be adhered to each other in a state that a clearance K2 on the inner circumference side of the adhesive projection 10 is different from a clearance K1 on the outer circumference side of the adhesive projection 10 over the entire circumference of the axis parallel to the sandwiching direction.

More specifically, as shown in FIG. 3, a centerline C3 in the thickness direction of the adhesive projection 10 (a centerline between the first side surface 10d and the second side surface 10e) is disposed closer to the outside by a dimension D1 than the centerline C1 of a width direction of the adhesion groove 7 of the second case 3, over the entire circumference of the axis parallel to the sandwiching direction. For this reason, as shown in FIG. 2, when the adhesive projection 10 is inserted into the adhesion groove 7, the clearance K1 between the second side surface 10e of the adhesive projection 10 and an inner side surface of the adhesion groove 7 is smaller than the clearance K2 between the first side surface 10d of the adhesive projection 10 and the inner side surface of the adhesion groove 7. Therefore, compared to when combining the centerline C1 and the centerline C3, a space for filling a fusion part 10m (see FIG. 2) of the adhesive projection 10 in the clearance K1 can be reduced. As a result, the adhesion sealability can be improved.

In addition, as shown in FIG. 3, length D4 of the first inclined surface 10c in the sandwiching direction is set to be shorter than length D3 of the second inclined surface 10b in the sandwiching direction. Because the volume of the adhesive projection 10 (the amount of material that can be fused) in the vicinity of the clearance K1 (see FIG. 2) can be increased, more of the fusion part 10m of the adhesive projection 10 can be guided to the clearance K1.

Moreover, the relationship between thickness D2 of the adhesive projection 10 (the distance between the first side surface 10d and the second side surface 10e) and the length D3 of the second inclined surface 10b in the sandwiching direction satisfies the following formula (I).

0.5≦D2/D3≦1 (1)

Specifically, in the present embodiment, the thickness D2 of the adhesive projection 10 is 0.48 mm, and the length D3 of the second inclined surface 10b in the sandwiching direction is 0.6 mm. Therefore, the value of D2/D3 is 0.8.

Setting the value of D2/D3 to be equal to or greater than 0.5 can prevent the tip end part of the adhesive projection 10 from becoming excessively sharp. Setting the value of D2/D3 to be equal to or lower than 1 can prevent the tip end part of the adhesive projection 10 from becoming excessively obtuse. Although described in detail later, satisfying the conditions of the formula (I) can prevent the tip end part of the adhesive projection 10 from bending at the time of the adhesion and securely perform the ultrasonic adhesion.

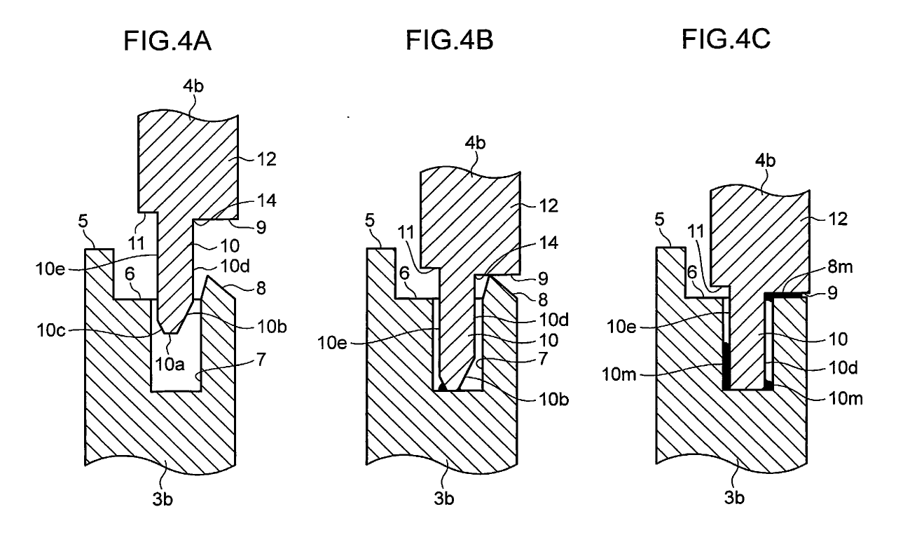

The operations of ultrasonically adhering the first case 4 and the second case 3 are described hereinafter with reference to FIG. 4.

FIG. 4 is a cross-sectional diagram showing a procedure of ultrasonically adhering the first case 4 and the second case 3 shown in FIG. 1, wherein FIG. 4A shows a state that the adhesive projection 10 is inserted into the adhesion groove 7, FIG. 4B shows a state that the ultrasonic adhesion is started, and FIG. 4C shows a state that the ultrasonic adhesion is completed.

First, as shown in FIG. 4A, the adhesive projection 10 is inserted into the adhesion groove 7. The tip end part of the adhesive projection 10 is provided with the first inclined surface 10c and the second inclined surface 10b. Therefore, even when the adhesive projection 10 comes into contact with the open rim of the adhesion groove 7, the adhesive projection 10 can be guided securely into the adhesion groove 7 along the inclined surfaces 10b, 10c.

When the adhesive projection 10 is inserted into a deep part of the adhesion groove 7, the tip end surface 10a of the adhesive projection 10 comes into contact with a bottom surface of the adhesion groove 7. In this state, an ultrasonic vibration is applied to the first case 4 or the second case 3 while the first case 4 and the second case 3 are pressed against each other. In the present embodiment, the tip end surface of the adhesive projection 10 is in the form of a flat surface substantially perpendicular to the sandwiching direction. For this reason, unlike when making the tip end part of the adhesive projection 10 pointy, the tip end part of the adhesive projection 10 can be prevented from bending when pressed against the bottom surface of the adhesion groove 7. A projection distance of the auxiliary adhesive projection 8 is set such that the auxiliary adhesive projection 8 of the second case 3 does not come into contact with the end surface 9 of the first case 4 when the tip end surface 10a of the adhesive projection 10 comes into contact with the adhesion groove 7.

When fusion of the adhesive projection 10 is started by the application of the ultrasonic vibration, a tip end part of the auxiliary adhesive projection 8 comes into contact with the end surface 9 of the first case 4, as shown in FIG. 4B. When the cases 3 and 4 are ongoingly pressed against each other and applied with ultrasonic vibrations, fusion of the auxiliary adhesive projection 8 also begins.

In the present embodiment, the centerline C3 of the adhesive projection 10 is disposed closer to the outside than the centerline C1 of the adhesion groove 7, as shown in FIG. 3. Therefore, compared to when combining the centerlines C1 and C3, the clearance K1 on the outside of the adhesive projection 10 can be made smaller. As a result, the fusion part 10m of the adhesive projection 10 can sufficiently fill the clearance K1, as shown in FIG. 4C, ensuring the sealability. Particularly, as shown in FIG. 3, the length D4 of the first inclined surface 10c of the adhesive projection 10 is set to be shorter than the length D3 of the second inclined surface 10b. For this reason, the volume of the adhesive projection 10 in the vicinity of the clearance K1 can be increased, and more of the fusion part 10m can be guided to the clearance K1.

As shown in FIG. 3, the auxiliary adhesive projection 8 tapers such that the tip end part thereof is positioned closer to the adhesive projection 10 than the centerline C2 on the base end side. For this reason, more of a fusion part 8m of the auxiliary adhesive projection 8 can be guided to the angular part 14 formed between the adhesive projection 10 and the end surface 9, as shown in FIG. 4C.

As described above, according to the embodiment the adhesive projection 10 is inserted into the adhesion groove 7 such that the position of the centerline C3 in the thickness direction of the adhesive projection 10 is different from the position of the centerline in the width direction of the adhesion groove 7. Therefore, in a case where the centerline C1 is disposed between one of the inner side surface of the adhesion groove 7 and the other of the inner side surface of the adhesion groove 7, the clearance K2 between one of the inner side surfaces of the adhesion groove 7 and the adhesive projection 10 becomes large over the entire circumference of the axis parallel to the sandwiching direction, and the clearance K1 between the other inner side surface and the adhesive projection 10 becomes small over the entire circumference of the axis parallel to the sandwiching direction. As a result, the space for filling the fusion part 10m of the adhesive projection 10 becomes small in the clearance K1, improving the sealability of the fusion part 10m.

The embodiment, therefore, is capable of achieving to ensure the operability of inserting the adhesive projection 10 into the adhesion groove 7 by making the adhesion groove 7 wider than the thickness D2 of the adhesive projection and the adhesion sealability.

In the embodiment described above, the adhesive projection 10 has the tip end surface 10a configured by a flat surface, and the first and second inclined surfaces 10c and 10b hat broaden from the tip end surface 10a to either side. Therefore, unlike the pointy tip end part of the adhesive projection 10, it is able to avoid problems of disabling an appropriate fusion of the adhesive projection 10 by bending the tip end of the adhesive projection 10 when the rip end of the adhesive projection 10 comes in contact with bottom surface of the adhesion groove 7 to be pressed.

Moreover, according to the embodiment described above, the length D4 of the first inclined surface 10c is shorter than the length D3 of the second inclined surface 10b. Therefore, the volume of the adhesive projection 10 (the amount of material that can be fused) in the vicinity of the inner side surface of the adhesion groove 7 can be increased. Consequently, more of the fusion part 10m of the adhesive projection 10 can be guided to the clearance K1 between the adhesive projection 10 and the side surface of the adhesion groove 7.

In the embodiment described above, the value obtained by dividing the thickness D2 of the adhesive projection 10 by the length D3 of the second inclined surface 10b is at least 0.5 but no more than 1. This allows secure fusion of the adhesive projection 10 while preventing the adhesive projection 10 from bending. More specifically, in the configuration described above, the value obtained by dividing the thickness D2 of the adhesive projection 10 by the length D3 of the second inclined surface 10b is equal to or greater than 0.5. This can prevent the tip end part of the adhesive projection 10 from becoming excessively sharp and the adhesive projection 10 from bending. In addition, since the value is set equal to or lower than 1, it is able to avoid a problem of disabling a fusion of the adhesive projection 10 regardless the application of the ultrasonic vibration on the ground that the tip end part of the adhesive projection 10 becomes excessively obtuse.

In the embodiment described above, the auxiliary adhesive projection 8 is provided in the second case 3 and the adhesion surface 9 is provided in the first case 4. Accordingly, the sealability can be ensured between the first case 4 and the second case 3 by fusing the auxiliary adhesive projection 8 in addition to the adhesive projection 10. Therefore, the sealability can be improved. In other words, although the auxiliary adhesive projection 8 and the adhesion surface 9 are not necessary in terms of ensuring the sealability between the first case 4 and the second case 3, high sealability can be achieved by providing the auxiliary adhesive projection 8 and the adhesion surface 9.

In the embodiment described above, the angular part 14 is formed between the adhesion surface 9 and the adhesive projection 10, and the auxiliary adhesive projection tapers when viewed cross-sectionally, such that the thickness central position on the tip end side of the auxiliary adhesive projection 8 is positioned closer to the angular part than the thickness central position of the base end part of the auxiliary adhesive projection 8. The fusion part 8m of auxiliary adhesive projection 8 can be proactively guided to the angular part 14 by fusing the auxiliary adhesive projection 8, so that the sealability can be further improved.

Note that in the embodiment above, the example in which the clearance K1 on the outside of the adhesive projection 10 is smaller than the clearance K2 on the inside of the adhesive projection 10 over the circumference of the axis parallel to the sandwiching direction has been described, but the present invention is not limited to this example. For instance, the clearance K1 can be made larger than the clearance K2 over the circumference of the axis parallel to the sandwiching direction.

In this case, it is preferred that the length D3 of the second inclined surface 10b on the clearance K2 side be shorter than the length D4 of the first inclined surface 10c on the clearance K1 side. Accordingly, as with the embodiment described above, more of the fusion part 10m of the adhesive projection 10 can be guided to the smaller clearance K2.

The second case 3 according to the embodiment has the tip end surface 5 projecting toward the first case 4 more than the lower part 6 in which the adhesion groove 7 is formed, but the protruding section having this tip end part 5 can be omitted.

Note that the specific embodiment described above mainly includes the inventions having the following configurations.

In order to achieve the object described above, the present invention provides a battery storage case, having: first and second cases for sandwiching and storing a battery therebetween in a predetermined sandwiching direction; an adhesive projection provided in the first case and projecting toward the second case over the entire circumference of an axis parallel to the sandwiching direction; and an adhesion groove provided in the second case and recessed over the entire circumference of the axis parallel to the sandwiching direction, wherein a width of the adhesion groove is set to be greater than a thickness of the adhesive projection, and the first case and the second case can be adhered to each other in a state that a clearance on an inner circumference side of the adhesive projection is different from a clearance on an outer circumference side of the adhesive projection over the entire circumference of the axis parallel to the sandwiching direction.

According to the present invention, the first case and the second case can be adhered to each other in a state that the clearance on the inner circumference side of the adhesive projection is different from the clearance on the outer circumference side of the adhesive projection over the entire circumference of the axis parallel to the sandwiching direction. As a result, the size of the space for filling the fusion part of the adhesive projection can be reduced in the smaller clearance, improving the sealability of the fusion part.

The present invention, therefore, is capable of ensuring between the operability of inserting the adhesive projection into the adhesion groove by making the adhesion groove wider than the thickness of the adhesive projection, and ensuring the adhesion sealability.

In the battery storage case, the adhesive projection preferably has a tip end surface configured by a flat surface substantially perpendicular to the sandwiching direction, and first and second inclined surfaces that are inclined at respective sides in a thickness direction of the adhesive projection by broadening from the tip end surface toward a base end. It is preferred that the first inclined surface be disposed closer to the smaller clearance than the second inclined surface, when the adhesive projection is inserted into the adhesion groove, and that the first inclined surface be shorter than the second inclined surface in terms of the sandwiching direction.

In this configuration, the tip end surface of the adhesive projection is a flat surface substantially perpendicular to the sandwiching direction. Therefore, unlike the pointy tip end part of the adhesive projection, it is able to avoid problems of disabling an appropriate fusion of the adhesive projection by bending the tip end of the adhesive projection when the tip end of the adhesive projection comes in contact with bottom surface of the adhesion groove to be pressed.

According to the configuration described above, the first inclined surface disposed on the small clearance side is shorter than the second inclined surface. Therefore, the volume of the adhesive projection (the amount of material that can be fused) can be increased in the small clearance. Consequently, more of the fusion part of the adhesive projection can be guided to this clearance.

In the battery storage case, it is preferred that the adhesive projection have a first side surface that extends from the first inclined surface to the base end along a direction substantially parallel to the sandwiching direction, and a second side surface that extends from the second inclined surface to the base end along a direction substantially parallel to the sandwiching direction, and that a value obtained by dividing a thickness of the adhesive projection between the first side surface and the second side surface by a length of the second inclined surface in the sandwiching direction be at least 0.5 but not more than 1.

This configuration can securely fuse the adhesive projection while preventing the adhesive projection from bending. Specifically, in the configuration described above, the value obtained by dividing the thickness between the first side surface and the second side surface by the length of the second inclined surface is equal to or greater than 0.5. This can prevent the tip end part of the adhesive projection from becoming sharp and the adhesive projection from bending. Moreover, since the value is set equal to or lower than 1, it is able to avoid a problem of disabling a fusion of the adhesive projection regardless the application of the ultrasonic vibration on the ground that the tip end part of the adhesive projection becomes excessively obtuse.

It is preferred that the battery storage case further have an auxiliary adhesive projection that is provided in the second case and projects toward the first case over the entire circumference of the axis parallel to the sandwiching direction, and an adhesion surface that is provided in the first case to adhere the auxiliary adhesive projection over the entire circumference of the axis parallel to the sandwiching direction.

According to this configuration, the sealability between the first case and the second case can be ensured by fusing auxiliary adhesive projection in addition to the adhesive projection. Therefore, the sealability can be further improved.

In the battery storage case, it is preferred that the adhesion surface extend from a side surface of the adhesive projection to form, between the adhesion surface and the side surface of the adhesive projection, an angular part for filling a fusion part of the auxiliary adhesive projection, and that the auxiliary adhesive projection have a tapered cross-sectional shape in such a manner that a thickness central position on a tip end side of the auxiliary adhesive projection is positioned closer to the angular part than a thickness central position of a base end part of the auxiliary adhesive projection.

In this configuration, the auxiliary adhesive projection extends toward the angular part formed by the side surface of the adhesive projection and the adhesion surface. Therefore, the fusion part of the auxiliary adhesive projection can be proactively guided to the angular part by fusing the auxiliary adhesive projection. Thus the sealability can be further improved.

The present invention also provides a battery pack that has a battery and the battery storage case, wherein the first case and the second case of the battery storage case are ultrasonically adhered to each other while sandwiching the battery therebetween.

### INDUSTRIAL APPLICABILITY

The present invention can maintain the balance between the workability of inserting an adhesive rib to an adhesion groove and ensuring adhesion sealability.

### EXPLANATION OF REFERENCE NUMERALS

C1 to C3 Centerline
K1, K2 Clearance
1 Battery pack
2 Battery
3 Second case
4 First case
7 Adhesion groove
8 Auxiliary adhesive projection
8m Fusion part
9 End surface (adhesion surface)
10 Adhesive projection
10a Tip end surface
10b Second inclined surface
10c First inclined surface
10d First side surface
10e Second side surface
10m Fusion part
14 Angular part

1. A battery storage case, comprising:
first and second cases for sandwiching and storing a battery therebetween in a predetermined sandwiching direction;
an adhesive projection provided in the first case and projecting toward the second case over the entire circumference of an axis parallel to the sandwiching direction; and
an adhesion groove provided in the second case and recessed over the entire circumference of the axis parallel to the sandwiching direction, wherein
a width of the adhesion groove is set to be greater than a thickness of the adhesive projection, and
the first case and the second case can be adhered to each other in a state that a clearance on an inner circumference side of the adhesive projection is different from a clearance on an outer circumference side of the adhesive projection over the entire circumference of the axis parallel to the sandwiching direction,
the battery storage case further comprising:
an auxiliary adhesive projection that is provided in the second case and projects toward the first case over the entire circumference of the axis parallel to the sandwiching direction; and
an adhesion surface that is provided in the first case to adhere the auxiliary adhesive projection over the entire circumference of the axis parallel to the sandwiching direction, wherein
the adhesion surface extends from a side surface of the adhesive projection to form, between the adhesion surface and the side surface of the adhesive projection, an angular part for filling a fusion part of the auxiliary adhesive projection, and wherein
the auxiliary adhesive projection has a tapered cross-sectional shape in such a manner that a thickness central position on a tip end side of the auxiliary adhesive projection is positioned closer to the angular part than a thickness central position of a base end part of the auxiliary adhesive projection.

2. The battery storage case according to claim 1, wherein
the adhesive projection has:
a tip end surface configured by a flat surface substantially perpendicular to the sandwiching direction; and
first and second inclined surfaces that are inclined at respective sides in a thickness direction of the adhesive projection by broadening from the tip end surface toward a base end,
the first inclined surface is disposed closer to the smaller clearance than the second inclined surface when the adhesive projection is inserted into the adhesion groove, and wherein
the first inclined surface is shorter than the second inclined surface in terms of the sandwiching direction.

3. The battery storage case according to claim 2, wherein
the adhesive projection has a first side surface that extends from the first inclined surface to the base end along a direction substantially parallel to the sandwiching direction, and a second side surface that extends from the second inclined surface to the base end along a direction substantially parallel to the sandwiching direction, and wherein
a value obtained by dividing a thickness of the adhesive projection between the first side surface and the second side surface by a length of the second inclined surface in the sandwiching direction is at least 0.5 but not more than 1.

4. (canceled)

5. (canceled)

6. A battery pack, comprising:
a battery; and
the battery storage case according to claim 1, wherein
the first case and the second case of the battery storage case are ultrasonically adhered to each other while sandwiching the battery therebetween.
